(19) United States
(12) Patent Application Publication
(10) Pub. No.: US 2013/0103388 A1
(43) Pub. Date: Apr. 25, 2013

(54) DOCUMENT ANALYZING APPARATUS

(71) Applicant: Chi Chen, New Taipei City (TW)

(72) Inventor: Chi Chen, New Taipei City (TW)

(21) Appl. No.: 13/653,194

(22) Filed: Oct. 16, 2012

(30) Foreign Application Priority Data
Oct. 20, 2011 (TW) 100219628

(51) Int. Cl. G06F 17/20

(52) U.S. Cl. 704/9

(57) ABSTRACT

A document analyzing apparatus includes a document analyzer and a comparator. The document analyzer is used for deconstructing a text file of a document stored in a data storage device to obtain a plurality of model sentences, and then storing the model sentences in the data storage device. The document analyzer further applies a position index to each of the model sentences, wherein the position index points to the storing position of the document having the model sentence in data storage device. The comparator is used for comparing a processing sentence and each of the model sentences for the similarity. The document analyzing apparatus in the present invention is capable of deconstructing text files into small units such as sentences so as to facilitate the user to search or classify the documents.

### PRIORITY CLAIM

This application claims the benefit of the filing date of Taiwan Patent Application No. 100219628, filed Oct. 20, 2011, entitled “DOCUMENT ANALYZING APPARATUS,” and the contents of which is hereby incorporated by reference in its entirety.

### FIELD OF THE INVENTION

The present invention relates to a document analyzing apparatus, and more particularly, to a document analyzing apparatus which can facilitate the user to search or classify the documents.

### BACKGROUND OF THE INVENTION

With the development and popularization of network technology, most of personal computers, notebook computers, tablet computers, intelligent mobile phones and/or other electronic devices have been internet enabled, thus accelerating the spread of information.

Internet is a global network based on ARPA, and the data volume on the internet is enormous, therefore efficient data search methods, databases, and search engines are helpful for users to find the information they need. For example, patent information over the world can be found by searching the databases on the websites of their intellectual property agencies.

In general, the conventional search methods use word-by-word comparison or keyword comparison to find out the high correlation documents as a search result. However, the same keyword or term in different fields may carry different significances and meanings, causing inaccuracy of searching or classifying documents by keyword. Besides, an inappropriate language translation may also bring incorrect information as well as affect the search results.

### SUMMARY OF THE INVENTION

Therefore, an aspect of the invention is to provide a document analyzing apparatus which is capable of deconstructing text files of documents into small units (such as sentences), so as to facilitate the user to search or classify the documents.

According to an embodiment of the present invention, the document analyzing apparatus comprises a document analyzer and a comparator. The document analyzing apparatus is used for deconstructing a text file of at least one document stored in a data storage device to obtain a plurality of model sentences; the document analyzer can further apply a position index to each of the model sentences, and the position index points to the storing position of the document having the model sentence in the data storage device. The comparator can compare the similarity of a processing sentence and each of the model sentences.

In the embodiment, the present invention further comprises a processor, and the processor can output the model sentences, the documents having the model sentences, or the categories of the documents in accordance with the similarity of the processing sentence and each of the model sentences, which is compared by the comparator. Accordingly, users can query and search sentences or documents, and further to classify the processing file with the document analyzing apparatus of the present invention.

Many other advantages and features of the present invention will be further understood by the detailed description and the accompanying sheet of drawings.

### BRIEF DESCRIPTION OF THE DRAWINGS

FIG. 1 is a schematic diagram illustrating a document analyzing apparatus according to an embodiment of the present invention.

FIG. 2 is a schematic diagram illustrating a document analyzing apparatus according to another embodiment of the present invention.

FIG. 3 is a schematic diagram illustrating a document analyzing apparatus according to another embodiment of the present invention.

To facilitate understanding, identical reference numerals have been used, where possible to designate identical elements that are common to the figures.

### DETAILED DESCRIPTION

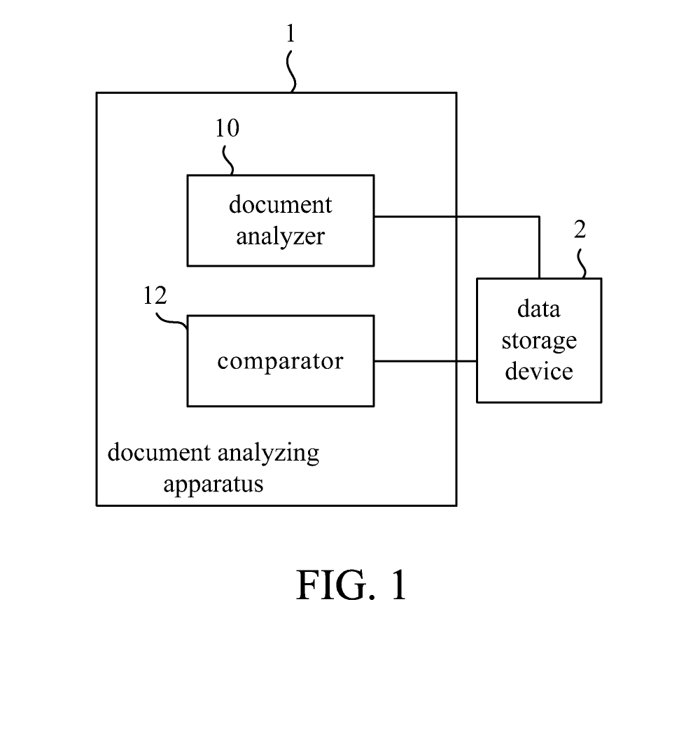

Please refer to FIG. 1. FIG. 1 is a schematic diagram illustrating a document analyzing apparatus 1 according to an embodiment of the present invention. As shown in FIG. 1, the document analyzing apparatus 1 comprises a document analyzer 10 and a comparator 12, wherein the document analyzer 10 and the comparator 12 can be respectively connected to a data storage device 2. The data storage device 2 can provide space for storing a plurality of documents, and each document can further comprise text files. To be noticed, the data storage device 2 is independent of the document analyzing apparatus 1 in this embodiment; however, in actual application, the data storage device 2 can be integrated into the document analyzing apparatus 1. For example, the document analyzing apparatus may be a personal computer or a workstation host, and the data storage device may be the hard disk thereof.

More specifically, the document analyzer 10 can analyze the documents stored in the data storage device 2 and deconstruct the text files of the documents to obtain a plurality of model sentences according to keywords, keyword combinations, syntaxes, and concepts, and then storing the model sentences in the data storage device 2; meanwhile, the document analyzer 10 further applies a position index to each of the model sentences, wherein the position index points to the storing position of the document having the model sentence in the data storage device 2. For example, the position index of each model sentence deconstructed from the document A may point to the storing position of the document A in the data storage device.

Moreover, the comparator 12 can compare the processing sentence and each of the model sentences deconstructed by the document analyzer 10 according to at least one of keywords, keyword combinations, syntaxes, and concepts; to be noticed, the comparator 12 executes the comparing process sentence by sentence, but not word-by-word comparison. For example, the comparator can adopt keywords and syntaxes to compare the similarity of a processing sentence and each of the model sentences; and the comparator may determine and judge the processing sentence has higher similarity with the model sentence only when the keywords and syntaxes thereof are coincided with each other. Furthermore, according to another embodiment, the comparator can adopt syntaxes and concept search to compare the similarity of a processing sentence and the model sentences; by the same token, the comparator may determine and judge the processing sentence and the model sentence are highly similar only when the comparison result is coincided.

Both of the document analyzer 10 and the comparator 12 mentioned above can deconstruct the text files or compare the processing sentence and the model sentences according to keywords, keyword combinations, syntaxes, and/or concepts; therefore, the comparator can be comprised in the document analyzer in actual application. On the other hand, after the document analyzer deconstructing a text file to obtain and store a plurality of model sentences, the comparator may be capable of proceeding the comparing process independently; that is to say, the document analyzer and the comparator can be separately configured in different apparatus. For example, the document analyzing apparatus can comprise at least two hosts, and the document analyzer and the comparator are separately configured in different hosts; after obtaining and storing the model sentences in the data storage device, the comparator in another host can proceed the comparing process independently without the assistance of the document analyzer; and wherein the data storage device can be configured in one of the two hosts or other apparatus.

More specifically, the model sentences obtained by deconstructing a text file with concepts may represent the important issue or the problem needs to be solved in the document; for instance, the main technical characteristics of a document (e.g., patent or academic document) are usually introduced in the conclusion and/or abstract thereof. Accordingly, the comparator is capable of proceeding the comparison for technology or function by comparing and/or concept matching the processing sentence and the model sentences which may represent the key point of the document.

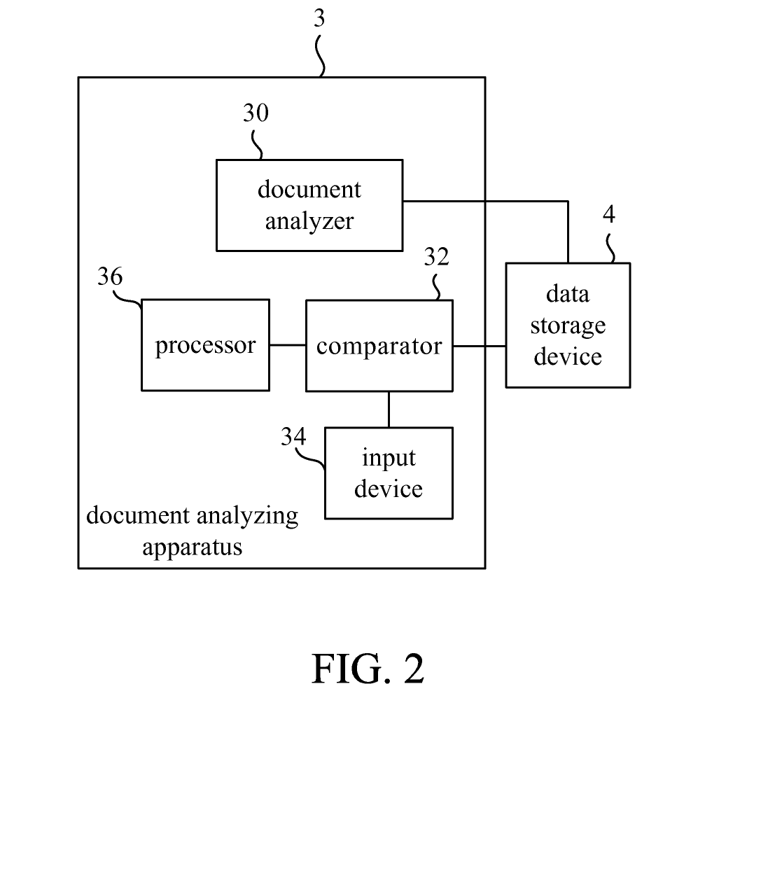

Please refer to FIG. 2. FIG. 2 is a schematic diagram illustrating a document analyzing apparatus 3 according to another embodiment of the present invention. As shown in FIG. 2, the difference between this embodiment and the one in FIG. 1 is that the document analyzing apparatus 3 further comprises an input device 34 and a processor 36, wherein the input device 34 and the processor 36 can be connected to the comparator 32 respectively.

In the embodiment, a user can input a processing sentence by the input device 34, and then the comparator 32 can compare the processing sentence received from the input device 34 and the model sentences stored in the data storage device 4 so as to obtain the similarity of a processing sentence and each of the model sentences. In addition, the processor 36 can produce an output in accordance with the comparison result generated from the comparator 32; wherein the form of the output can be model sentences, document having the model sentences, or categories of the documents.

According to the embodiment, the document analyzing apparatus 3 can be utilized for querying the writing methods of specific documents, such as patent claims; more specifically, when a user inputs a rough sentence, the comparator 32 may compare the similarity of this sentence and each model sentence in patent claims word by word or phrases by phrases and according to the syntaxes, and subsequently the processor 36 may show the model sentences on a monitor (not shown in the figures) in the order of similarity. In the embodiment, the comparison result is a complete sentence which can be adopted as a reference.

In another embodiment, the document analyzing apparatus 3 can be utilized for querying the technical documents of a specific field; when a user inputs a processing sentence belonged to the specific field, the comparator 32 may execute concept search and comparison between the processing sentence and each model sentence stored in the data storage device 4, and then the model sentences with high similarity or the documents thereof may be displayed on a monitor. According to the embodiment, the comparison result is a representative sentence in the specific field or the document thereof, thus related researches can be executed.

Furthermore, the document analyzer 30 can convert each of the model sentences to other languages and store them in the data storage device 4; for example, Chinese model sentences can be translated into English model sentences and be stored in a data storage device; therefore, the comparator 32 can compare the similarity of an English processing sentence and the English model sentences. On the other hand, the document analyzer 30 can execute language conversion of the model sentences or not; that is to say, the comparator 32 of the embodiment may have a language converting function so as to convert the language of the processing sentence to another language which is the same with the model sentences, and for the subsequent processing; for instance, the comparator 32 may translate an English processing sentence into a Chinese processing sentence, and further to compare the similarity of the Chinese processing sentence and the Chinese model sentences. Accordingly, the document analyzing apparatus 3 can achieve the function of cross-language comparison.

In another embodiment, the processor 36 can output and display the documents having the model sentences on a monitor in accordance with the similarity compared by the comparator 32. For example, when a user inputs a processing sentence belonged to a specific field, the comparator 32 may compare the similarity in the manner described above so as to obtain the model sentences with high similarity, and then, the processor 36 may find out the corresponding patent documents having these model sentences according to the position indexes of these model sentences and display the patent documents on a monitor in sequence. According to the embodiment, the comparison result is a complete document, i.e., the document analyzing apparatus 3 in the embodiment is capable of searching the documents accurately through inputting a processing sentence.

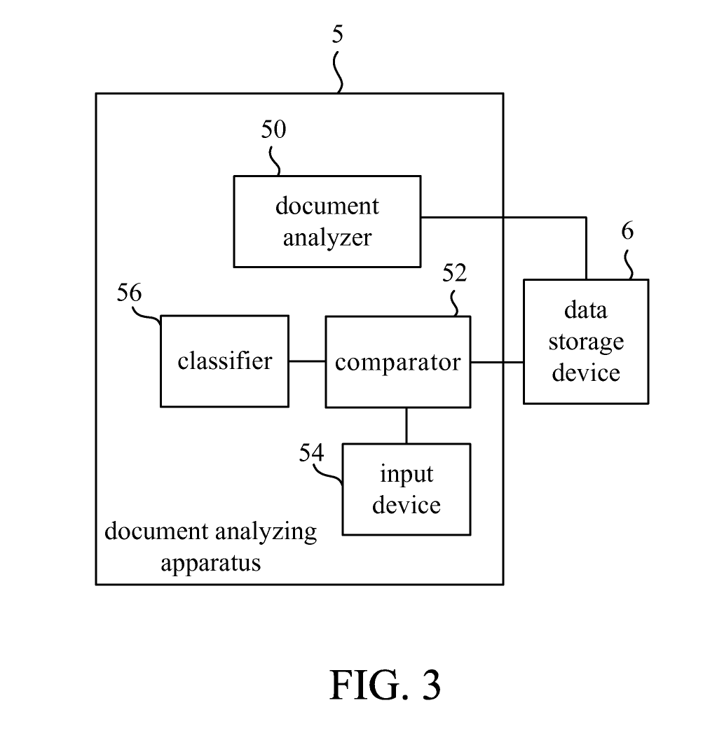

Besides searching by inputting a sentence, the input device can allow a user to input an entire processing file to execute the comparing process. Please refer to FIG. 3. FIG. 3 is a schematic diagram illustrating a document analyzing apparatus 5 according to another embodiment of the present invention. As shown in FIG. 3, the difference between this embodiment and the embodiments described above is that the document analyzing apparatus 5 further comprises a classifier 56. In this embodiment, a user can input a processing file by the input device 54 and specify one or more processing sentences in the processing file; subsequently, the comparator 52 can execute the comparing process for each processing sentence. Other components of this embodiment are substantially the same as the corresponding components of the embodiment mentioned previously, thus a description thereof is omitted herein.

In the embodiment, the comparator 52 can compare the documents stored in a data storage device 6 in order. For example, a plurality of patent documents are stored in the data storage device 6, and the comparator 52 can compare the similarity of a processing sentence and each the model sentence in one of the patent documents first, so as to obtain the similarity of the processing file and the patent document. To be noticed, the comparator 52 compares the similarity according to a character factor; in actual application, the character factor is a specific combination of keywords, key sentences, and concepts, such as a semantically meaningful combination or a main block of article. Subsequently, the comparator 52 may repeat the comparing process with another patent document; and the classifier 56 may classify the processing file as the same category of the patent document with high similarity according to the similarity compared by the comparator 52.

In general, each patent document has its patent classification number, such as International Patent Classification (IPC) or United States Patent Classification (UPC); that is to say, the processing file and the patent document with high similarity can have the same patent classification number. Accordingly, the processing file can be classified automatically. To be noticed, the present invention is not limited only to the embodiments described above; the document analyzing apparatus of the present invention enables to classify any type of documents patent document.

However, the same keyword or term in different fields may carry different significances and meanings, causing inaccuracy of searching or classifying documents by keyword. In order to improve the problem, the document analyzing apparatus of the present invention deconstructs the text files of the documents according to at least one of keywords, keyword combinations, syntaxes, and concepts.

Besides, the document analyzer of the embodiment described above can analyze and deconstruct a specific block of the text file of the document to obtain to a plurality of first model sentences, wherein the specific block can be a conclusion or abstract of an article; since the number of the first model sentences is less than the number of the model sentences in the entire text file, the comparison frequency can be reduced so as to increase the comparison efficiency.

According to the above, the document analyzing apparatus in the present invention is capable of deconstructing text files of the documents stored in the data storage device into small units so as to obtain a plurality of model sentences. Compare with the prior art, the comparator of the document analyzing apparatus can execute the comparing process sentence by sentence, and further to provide the function of querying sentences so as to facilitate the user to search or classify the documents accurately.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A document analyzing apparatus, comprising:
a document analyzer for deconstructing a text file of at least one document stored in a data storage device to obtain a plurality of model sentences, and storing the model sentences in the data storage device; and
a comparator for comparing similarity of a processing sentence and each of the model sentences;
wherein, the document analyzer further applies a position index to each of the model sentences, and the position index points to the storing position of the document having the model sentence in the data storage device.

2. The document analyzing apparatus of claim 1, further comprising:
an input device for a user to input the processing sentence; and
a processor for outputting the model sentences sequentially in accordance with the similarity of the processing sentence and each of the model sentences, which is compared by the comparator.

3. The document analyzing apparatus of claim 1, further comprising:
an input device for a user to input the processing sentence; and
a processor for outputting the document having the model sentences in accordance with the similarity of the processing sentence and each of the model sentences, which is compared by the comparator.

4. The document analyzing apparatus of claim 1, wherein the document analyzer deconstructs the text file to obtain the model sentences according to at least one of keywords, keyword combinations, syntaxes, and concepts.

5. The document analyzing apparatus of claim 1, wherein the comparator compares the similarity of the processing sentence and each of the model sentences according to at least one of keywords, keyword combinations, syntaxes, and concepts.

6. The document analyzing apparatus of claim 1, further comprising:
an input device for a user to input a processing file which comprises the processing sentence; and
a classifier for determining the similarity of the processing file and the document in accordance with the similarity of the processing sentence and each of the model sentences, which is compared by the comparator.

7. The document analyzing apparatus of claim 6, wherein the comparator compares the similarity of the processing sentence and each of the model sentences according to a character factor, and the character factor is a specific combination of keywords, key sentences, and concepts.

8. The document analyzing apparatus of claim 6, wherein the document analyzer is used for analyzing a specific block of the text file of the document to obtain a plurality of first model sentences; the comparator is used for comparing the similarity of the processing sentence and each of the first model sentences; and the classifier is used for determining the similarity of the processing file and the document in accordance with the similarity of the processing sentence and each of the first model sentences, which is compared by the comparator.

9. The document analyzing apparatus of claim 6, wherein the document has a classification number, and the classifier determines whether the classification number of the processing file is the same as the classification number of the document according to the similarity of the processing file and the document.

10. The document analyzing apparatus of claim 1, wherein the document analyzer is used for deconstructing the text file of the document which belongs to patent document.

11. The document analyzing apparatus of claim 1, wherein each of the model sentences is respectively composed of a first language, and the processing sentence is composed of a second language; the document analyzer can convert each of the model sentences to a first model sentence composed of the second language and store the first model sentences in the data storage device; and the comparator is used for comparing the similarity of the processing sentence and each of the first model sentences.

12. The document analyzing apparatus of claim 11, wherein each of the model sentences is respectively composed of a first language, and the processing sentence is composed of a second language; the comparator is used for converting the processing sentence to a first processing sentence composed of the first language and comparing the similarity of the first processing sentence and each of the model sentences.
